(19) United States
(12) Patent Application Publication
(10) Pub. No.: US 2023/0049740 A1
(43) Pub. Date: Feb. 16, 2023

(54) PLANTER WITH MULTIPART CONSTRUCTION

(71) Applicant: THE HC COMPANIES, INC., Twinsburg, OH (US)

(72) Inventors: Yuebai Xiao, Mississauga (CA); Drew Keeble, Cleveland, OH (US)

(21) Appl. No.: 17/403,007

(22) Filed: Aug. 16, 2021

(51) Int. Cl. A01G 9/02

(52) U.S. Cl. CPC A01G 9/02

(57) ABSTRACT

A planter includes an upper part having an inner side wall and a bottom wall that define a chamber for receiving a growing medium and one or more plants, the upper part further having an outer wall radially outward from the inner side wall, the outer wall having a first joining element and the bottom wall having a first connector element; and a lower part having an outer wall radially outward of the inner side wall of the upper part and a bottom wall subjacent the bottom wall of the upper part, the outer wall of the lower part having a second joining element that engages with the first joining element to join the outer walls of the upper and lower parts, and the bottom wall of the lower part having a second connector element to mate with the first connector element.

### TECHNICAL FIELD

This disclosure relates to horticultural containers in the form of planters that are made from more than one part that are assembled together.

### BACKGROUND

The ornamental appearance of planters tends to be of high interest to consumers. To manufacture some planters having visually interesting features, the planters are made from more than one part. The parts are assembled to complete the planter. But this may result in various issues.

For instance, planters age over time, especially when exposed to sunlight. As a result of aging, the parts may warp. If the parts warp unevenly, undesired gaps may form between the parts.

Also, if the planters are assembled in a factory, the assembled planter may consume a relatively large volume, and multiple planters may not be nested together. As a result, more volume is consumed during storing and shipping, and more packaging may be required to package the assembled planters for shipping purposes.

### SUMMARY

There is a need in the art for an improved multipart planter that ages better than prior art planters and that consumes less volume when shipped.

According to one aspect of the disclosure, a planter includes an upper part having an inner side wall and a bottom wall that define a chamber for receiving a growing medium and one or more plants, the upper part further having an outer wall radially outward from the inner side wall, the outer wall having a first joining element and the bottom wall having a first connector element; and a lower part having an outer wall radially outward of the inner side wall of the upper part and a bottom wall subjacent the bottom wall of the upper part, the outer wall of the lower part having a second joining element that engages with the first joining element to join the outer walls of the upper and lower parts, and the bottom wall of the lower part having a second connector element to mate with the first connector element.

### BRIEF DESCRIPTION OF DRAWINGS

FIG. 1 is a perspective view of a representative planter having two part construction.

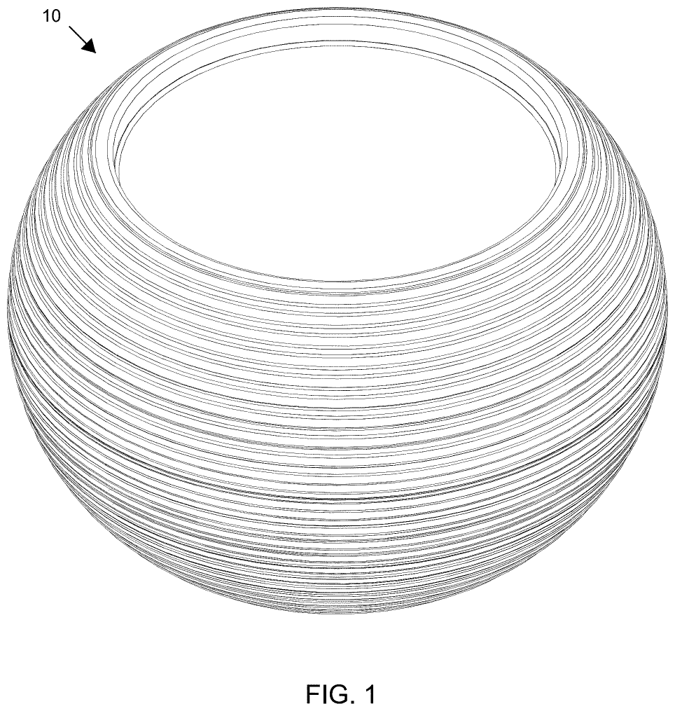

FIG. 2 is another perspective view of the planter.

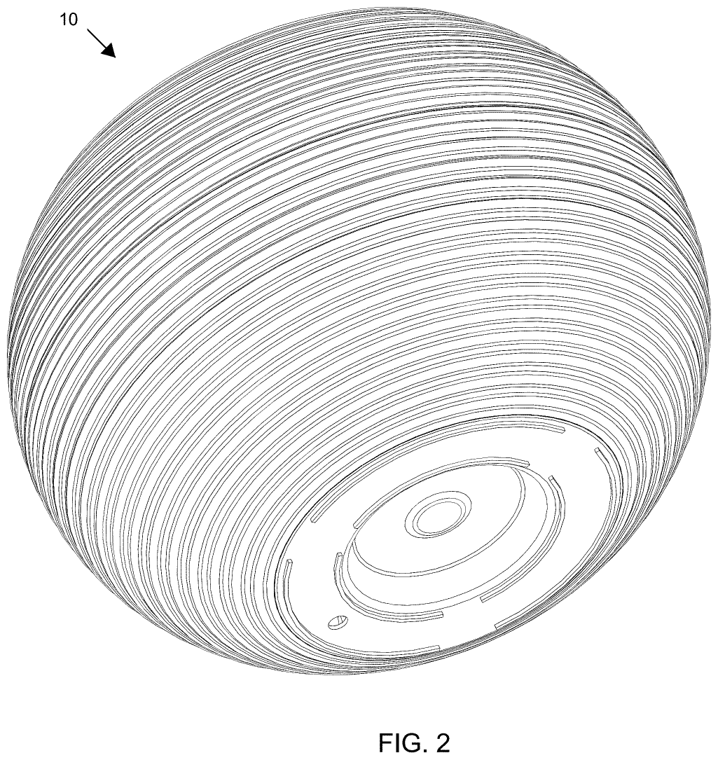

FIG. 3 is a front view of the planter.

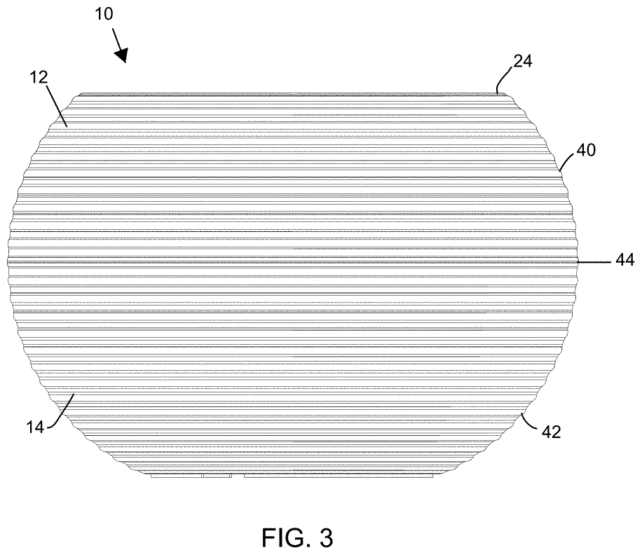

FIG. 4 is a top view of the planter.

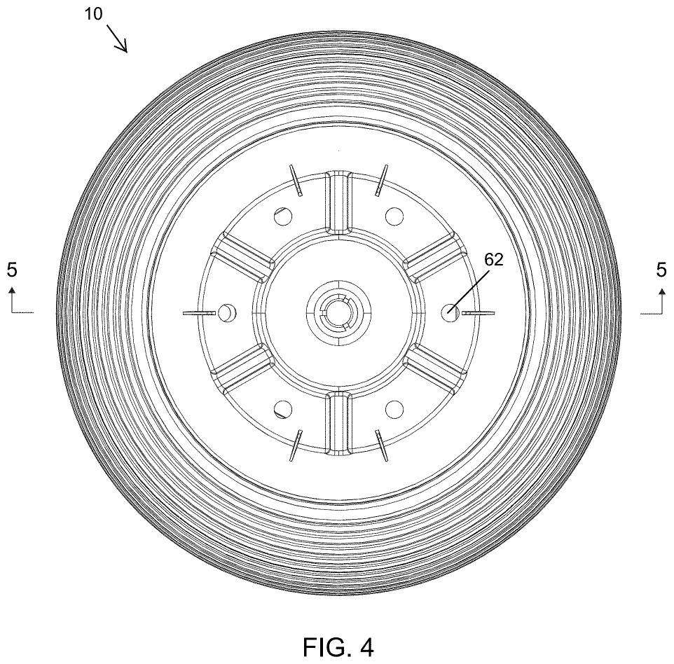

FIG. 5 is a cross-section of the planter taken along the line 5-5 in FIG. 4.

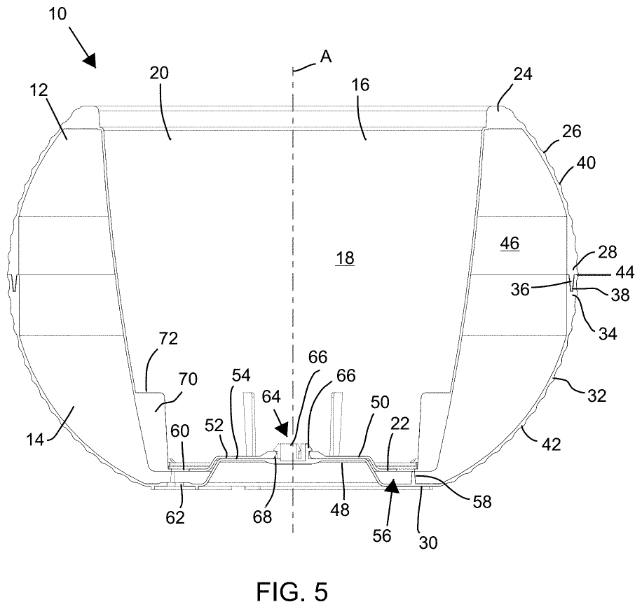

FIG. 6 is the cross-section of FIG. 5 where a lower part of the planter omitted.

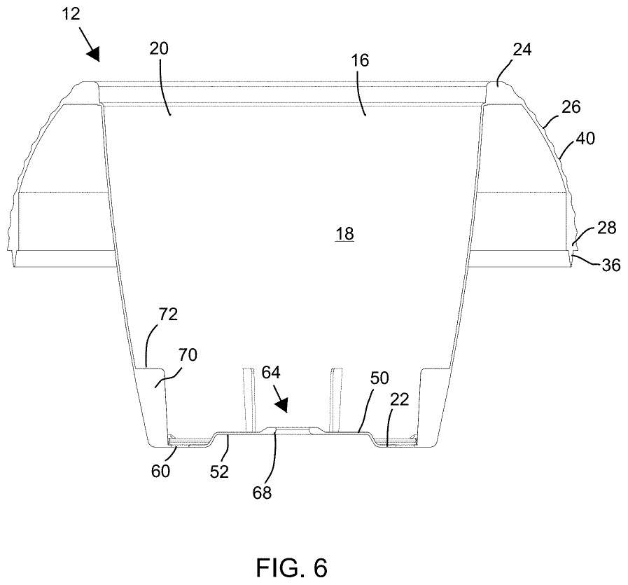

FIG. 7 is the cross-section of FIG. 5 where an upper part of the planter omitted.

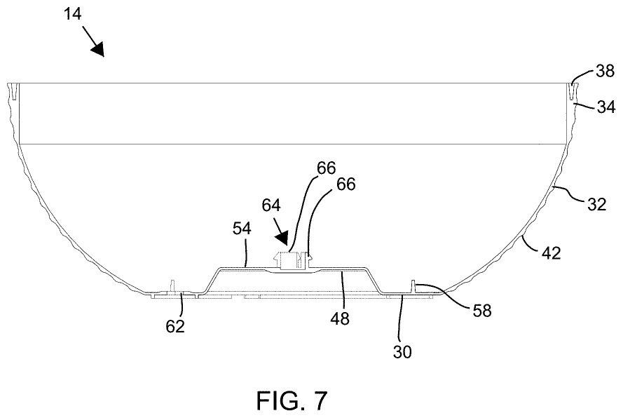

FIG. 8 shows the planter in rendered format and is cross-section taken along the line 5-5, but where the planter is shown in perspective.

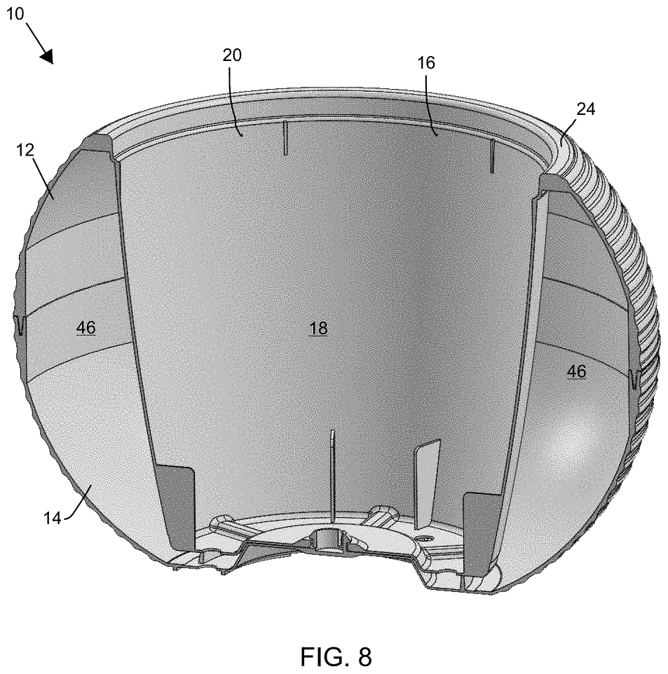

FIG. 9 shows two upper planter parts in cross-section and in stacked relationship.

### DETAILED DESCRIPTION

The figures are to scale, but it will be understood that the various views may be enlarged or reduced relative to one another. Also, the dimensions of the planter may be altered (e.g., the planter may be made taller without being made comparatively wider or vice versa, and/or other changes may be made).

Embodiments will be described with reference to the figures, wherein like reference numerals are used to refer to like elements throughout. Features that are described and/or illustrated with respect to one embodiment may be used in the same way or in a similar way in one or more other embodiments and/or in combination with or instead of the features of the other embodiments.

Referring to the figures, illustrated is a planter 10 having an upper part 12 and a lower part 14. The upper part 12 has an inner wall 16 that forms a chamber 18 for receiving planting medium (not shown), such as soil, and one or more plants (not shown). The inner wall 16 includes a least one side wall 20 and a bottom wall 22 that form the chamber 18, which is open at an upper end thereof.

The upper part 12 has an upper rim 24, at which an upper end of the side wall 20 ends. The side wall 20 may be tapered inward as it extends from the upper rim 24 to the bottom wall 22. The upper part 12 further includes an outer wall 26 that extends outward and downward from the upper rim 24. The outer wall 26 has a terminal edge 28 at about the mid-point of the height of the planter 10. In other embodiments, the terminal edge 28 may be located above or below the mid-point of the height of the planter 10.

The lower part 14 is configured in complementary fashion with the upper part 12 so that the lower part 14 and the upper part 12 may be assembled to form the planter 10. Assembly of the planter 10 will be described in greater detail below. The lower part 14 includes a bottom wall 30 that supports the bottom wall 22 of the upper part 12 and an outer wall 32. The outer wall 32 of the lower part 14 extends outward and upward from an outer periphery of the bottom wall 30 of the lower part 14. The outer wall 32 has a terminal edge 34 that joins with the terminal edge 28 of the upper part 12 using joining elements that are respectively located at the terminal edge 28 of the upper part 12 and the terminal edge 34 of the lower part 14.

For instance, in the illustrated embodiment, the terminal edge 28 of the upper part 12 has a tongue 36 that is received in a mating groove 38 in the terminal edge 34 of the lower part 14. In other embodiments, the terminal edge 34 of the lower part 14 may have the tongue 36 and the terminal edge 28 of the upper part 12 may have the groove 38. The fit of the tongue 36 in the groove 38 may have a tight tolerance to form a solid union between the upper part 12 and the lower part 14. A transition fit (e.g., requiring light or moderate force for the tongue 36 to fully seat within the groove 38) or an interference fit (e.g., a press fit or a friction fit) are exemplary fits suitable to create the tight tolerance to join upper part 12 and the lower part 14. In some planters, a clearance fit between the tongue 26 and the groove 38 may be satisfactory. Other unions between the terminal edge 28 of the upper part 12 terminal edge 34 of the lower part 14 rather than a tongue and groove union may be used, such as snap fit employing interlocking components (e.g., any of cantilever components, torsional components, annular components, etc.) or coordinating indents and detents. In other embodiments, a bayonet type of connection between the terminal edge 28 of the upper part 12 and the terminal edge 34 of the lower part 14 may be made.

In the illustrated embodiment, the tongue 28 and the groove 38 are circular about a longitudinal axis A and completely surround the longitudinal axis A of the planter 10. In this manner, the upper part 12 and the lower part 14 may be fit together in any relative rotational alignment. In other embodiments, the tongue 28 and the groove 38 are not completely annular and/or other features are present (e.g., alignment tabs, snap fit elements, bayonet connectors, etc.) that limit assembly of the planter 10 to specific relative annular alignments of the upper part 12 and the lower part 14 or that limit assembly of the planter 10 to a range of relative annular alignments of the upper part 12 and the lower part 14.

In the illustrated embodiment, the planter 10 is circular about the longitudinal axis A. Also, the outer wall 26 of the upper part 12 and the outer wall 32 of the lower part 14 are curved so that the planter 10 has a spherical appearance. Other shapes are possible, such as oval, triangular, square, rectangular, other polygons, and non-uniform shapes. Shapes of the planter 10 about the longitudinal axis A other than round will tend to require rotational alignment of the upper part 12 and the lower part 14 when assembling the planter 10. As indicated, a round planter 10 about the longitudinal axis A with round joining elements may be assembled in any relative rotational alignment between the upper part 12 and the lower part 14.

An exterior side 40 of the outer wall 26 and an exterior side 42 of the outer wall 32 may have ornamental features, such as a pattern. In the illustrated embodiment, the exterior sides 40, 42 have horizontal ridges and valleys that form a sinusoidal-like pattern. As will be appreciated, other patterns are possible. Horizontal features may assist in visually obscuring a seam 44 between the upper part 12 and the lower part 14.

A cavity 46 may be formed between the outer walls 26, 32 and the inner wall 16 of the upper part 12. The cavity 46 may be filled with air. Alternatively, the cavity 46 may serve as a reservoir for water in the case where the planter 10 is made to be self-watering. In other embodiments, ribs or other structural members may be formed in the cavity 46 to provide structural support between the outer wall 26 and the inner wall 16 and/or between the outer wall 32 and the inner wall 16.

The bottom wall 30 of the lower part 14 supports the bottom wall 22 of the upper part 12. In one embodiment, the bottom wall 30 has an upward projecting mesa 48 that nests within an upward projecting mesa 50 of the bottom wall 22. A lower surface 52 of the mesa 50 rests on an upper surface 54 of the mesa 48. In the illustrated embodiment, the mesas 48, 50 are circular about the longitudinal axis A so specific rotational alignment between the upper part 12 and the lower 14 during assembly is not required. The bottom walls 22, 30 may be spaced apart outside the mesas 48, 50 to create a volume 56 into which water from the chamber 18 may drain. To provide subjacent support to the bottom wall 22 outside the mesas 48, 50, an upper surface of the bottom wall 30 of the lower part 14 may include upwardly projecting features (e.g., ribs 58) that contact the bottom wall 22 of the upper part 12. Alternatively, or in addition to the ribs 58, the lower surface of the bottom wall 22 may include downwardly projecting features (e.g., ribs) outside the mesas 48, 50 that contact the bottom wall 30. One or more drainage holes 60 in the bottom wall 22 of the upper part 12 may fluidly connect the chamber 18 with the volume 56 to allow water to drain from the chamber 18 to the volume 56 and/or to be wicked into the chamber 18 from the volume 56. The volume 56 may open to the cavity 46 at the outer peripheral edge of the bottom wall 22. One or more drainage holes 62 in the bottom wall 30 of the lower part 14 may fluidly connect the volume 56 to an exterior environment of the planter 10 to allow for further drainage and/or self-watering capability.

The planter 10 may include a connector 64 to secure the upper part 12 to the lower part 14. In the illustrated embodiment, the connector 64 includes snap fit members 66, 68. For instance, protruding upward from the upper surface 54 of the mesa 48 of the bottom wall 30 are three snap fit cantilever members 66 with catch features that protrude through a through hole 68 in the in the mesa 50 of the bottom wall 22 of the upper part 12. During assembly, the members 66 deflect inward against the sides of the hole 68 and, once clear of the bottom wall 22, resiliently snap back so as to engage the bottom wall 22 and trap the bottom wall 22 of the upper part 12 between the catch features and the upper surface 54 of the mesa 48 of the bottom wall 30 of the lower part 14. This locks the upper part 12 to the lower part 14. The hole 68 and members 66 are circular about the longitudinal axis A and aligned with the longitudinal axis A to allow assembly of the planter 10 in any relative rotational alignment between the upper part 12 and the lower part 14. Fewer or more than three members 66 may be present. Also, other types of connectors 64 are possible, such as annular or torsional snap fit members, or a bayonet-style fitting. Alternatively, the members 66 and corresponding structure of the upper part 12 (e.g., the hole 68) need not be aligned with the longitudinal axis A. In another embodiment, the members 66 may be part of the upper part 12 and the lower part 14 may have corresponding structure (e.g., a hole).

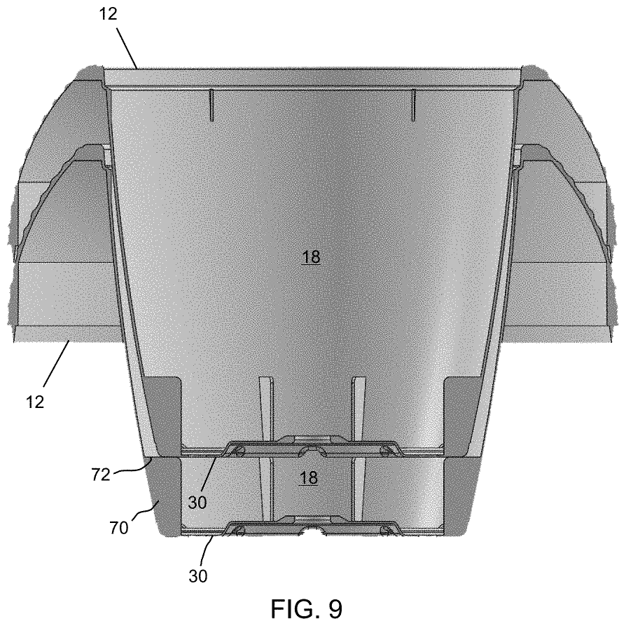

The upper part 12 and the lower part 14 may be manufactured separately. In one embodiment, the parts 12, 14 may be made by injection molding from plastic material, or by another appropriate technique and/or from another material. As best shown in FIG. 9, multiple upper parts 12 may be stacked together in nested fashion for shipping. Similarly, multiple lower parts 14 may be stacked together in nested fashion for shipping. Shipping one or more stacks of the upper parts 12 and one or more stacks of the lower parts 14 reduces overall volume as compared to the volume needed to ship assembled planters 10. To facilitate nesting of the upper parts 12, the upper part 12 may include ribs 70 that each terminate in a shoulder 72 spaced above the bottom wall 22. When stacked, the shoulders 72 support the bottom wall 22 of an adjacent upper part 12, as shown in FIG. 9.

Once the upper parts 12 and lower parts 14 arrive at a destination, they may be assembled to form assembled planters 10. For example, a worker at store may assembly the planters 10 from the upper parts 12 and the lower parts 14 for retail sale. In another situation, a worker at a commercial grower may assembly the planters 10 for use in planting one or more plants in each of the planters 10. Alternatively, the upper part 12 and the lower part 14 could be separated at sale and the end consumer could assemble the planter 10. To assemble the planter 10, un upper part 12 is fit to the lower part 14 so that the joining elements at the terminal edges 28, 34 of the outer walls 26, 32 engage each other and so that the connector 64 secures the upper and lower parts 12, 14 to each other. In embodiments where the upper and lower parts 12, 14 do not need any specific rotational alignment relative to one another, the assembly of multiple planters 10 is considered to be intuitive and not labor intensive (e.g., not requiring much time per planter 10). This is true even in embodiments where rotational alignment of the upper and lower parts 12, 14 is needed.

Other advantages of the disclosed planter 10 are contemplated. For instance, the upper and lower parts 12, 14 do not have undercuts that would require corresponding tooling, molding techniques, and/or machining techniques for manufacture. At the same time, planters 10 with unconventional ornamental features may be made, such as the illustrated planter 10 having external side walls that bow outward in spherical fashion rather than most conventional planters that have walls that taper inward along the direction from the upper rim toward the bottom wall. Also, joining elements at the terminal edges 28, 34 allow the upper and lower parts 12, 14 to age relatively evenly. Therefore, if warping of the parts 12, 14 occur, it is thought that the terminal edges 28, 34 will tend not to separate from one another so that the seam 44 remains tight and less visually noticeable.

Although certain embodiments have been shown and described, it is understood that equivalents and modifications falling within the scope of the appended claims will occur to others who are skilled in the art upon the reading and understanding of this specification.

What is claimed is:

1. A planter, comprising:
an upper part having an inner side wall and a bottom wall that define a chamber for receiving a growing medium and one or more plants, the upper part further having an outer wall radially outward from the inner side wall, the outer wall having a first joining element and the bottom wall having a first connector element; and
a lower part having an outer wall radially outward of the inner side wall of the upper part and a bottom wall subjacent the bottom wall of the upper part, the outer wall of the lower part having a second joining element that engages with the first joining element to join the outer walls of the upper and lower parts, and the bottom wall of the lower part having a second connector element to mate with the first connector element.

2. The planter of claim 1, wherein mating of the first and second connector elements secures the upper part with the lower part.

3. The planter of claim 2, wherein the first and second connectors comprise snap fit elements.

4. The planter of claim 2, wherein the upper and lower parts are securable to one another in any relative rotational alignment to one another.

5. The planter of claim 1, wherein the first and second joining elements comprise a tongue element and a groove element.

6. The planter of claim 5, wherein the tongue element and the groove element engage each other with a transition fit or an interference fit.

7. The planter of claim 1, wherein the upper and lower parts are securable to one another in any relative rotational alignment to one another.

8. The planter of claim 1, wherein the bottom walls of the upper and lower parts comprise respective mesas, the mesa of the lower part nesting within the mesa of the upper part.

9. The planter of claim 1, wherein the connector elements are circular about a longitudinal axis of the planter.

10. The planter of claim 9, wherein the connector elements are aligned with a longitudinal axis of the planter.

11. The planter of claim 1, wherein the joining elements are circular about a longitudinal axis of the planter.

12. The planter of claim 1, wherein the outer walls of the upper and lower parts and the inner side wall of the upper part form a cavity radially outward of the chamber.

13. The planter of claim 1, wherein at least a portion of the bottom wall of the upper part is spaced above at least a portion of the bottom wall of the lower part to form a volume therebetween.

14. The planter of claim 1, wherein:
the planter is circular about a longitudinal axis of the planter;
the inner side wall of the upper part has an upper rim at an upper end of the inner side wall, and the outer wall of the upper part curves outward and downward from the upper rim; and
the outer wall of the lower part curves outward and upward from a periphery of the bottom wall of the lower part.

15. The planter of claim 1, wherein exterior surfaces of the outer walls of the upper and lower parts comprise one or more features to visually obscure a seam between the upper and lower parts.

16. The planter of claim 15, wherein the features comprise horizontal ridges.
